(19) United States
(12) Patent Application Publication
(10) Pub. No.: US 2007/0247056 A1
(43) Pub. Date: Oct. 25, 2007

(54) ELECTRON EMISSION DISPLAY

(76) Inventors: Su-Kyung Lee, Yongin-si (KR); Seung-Joon Yoo, Yongin-si (KR); Zin-Min Park, Yongin-si (KR); Jung-Ho Kang, Yongin-si (KR); Won-Il Lee, Yongin-si (KR)

Correspondence Address: CHRISTIE, PARKER & HALE, LLP, PO BOX 7068, PASADENA, CA, 91109-7068, US

(21) Appl. No.: 11/689,258

(22) Filed: Mar. 21, 2007

(30) Foreign Application Priority Data
Apr. 20, 2006 (KR) 10-2006-0035825

(51) Int. Cl. H01J 1/62

(52) U.S. Cl. 313/496

(57) ABSTRACT

An electron emission display is provided including first and second substrates facing each other. The second substrate has a plurality of pixel regions defined thereon. A plurality of electron emission elements are disposed on the first substrate. A phosphor screen including phosphor and black layers are formed on a surface of the second substrate. An anode electrode formed of metal is located on surfaces of the phosphor and black layers. The anode electrode includes a spaced portion corresponding to the phosphor layers and spaced apart from the phosphor screen, and includes contact portions contacting the phosphor screen, and satisfies the condition 0.05≦B/A≦0.8, where A indicates an area of one of said pixel regions defined on the second substrate and B denotes an area occupied by one of the contact portions in the one of said pixel regions.

### CROSS-REFERENCE TO RELATED APPLICATION

This application claims priority to and the benefit of Korean Patent Application No. 10-2006-0035825, filed in the Korean Intellectual Property Office on Apr. 20, 2006, the entire content of which is incorporated herein by reference.

### BACKGROUND OF THE INVENTION

1. Field of the Invention

The present invention relates to an electron emission display and, more particularly, to an electron emission display having a contact area between an anode electrode and a black layer.

2. Description of Related Art

Electron emission elements can be classified into those using hot cathodes as an electron emission source, and those using cold cathodes as an electron emission source.

There are several types of cold cathode electron emission elements, including field emitter array (FEA) type electron emission elements, metal-insulator-metal (MIM) type electron emission elements, metal-insulator-semiconductor (MIS) type electron emission elements, and surface conduction emitter (SCE) type electron emission elements.

Although the different types of the electron emission elements differ with respect to the electron emission principle and the specific structure employed, each of the different types still includes an electron emission region and driving electrodes for controlling an electron emission of the electron emission region.

A plurality of electron emission elements are arrayed on a first substrate to form an electron emission unit. A light emission unit having a phosphor layer, a black layer, and an anode electrode is formed on a surface of a second substrate opposing the first substrate. The combination of the first and second substrates forms an electron emission display.

In the electron emission display, a metal layer formed of aluminum (Al) may be used as an anode electrode. The anode electrode is formed to cover a phosphor layer and a black layer. The anode electrode reflects visible light, which is emitted from the phosphor layer toward the first substrate back to the second substrate to enhance a screen luminance.

The phosphor layer is formed by depositing phosphor particles each having a size of several micrometers (μm) and the anode electrode is formed to have a thickness of thousands of A determined according to an electron transmittance. Therefore, when the aluminum is directly deposited on the surface of the phosphor layer, the anode electrode is directly affected by a roughness of the phosphor particles and a desired light reflection effect may not be obtained. As a result, the screen luminance may not be enhanced.

Accordingly, in order to solve the above problem, an interlayer made of a polymer material that will be vaporized through a baking process is formed on the phosphor and black layers formed on the second substrate, and metal (e.g., aluminum) is deposited on the interlayer. Since the anode electrode is deposited on the interlayer, the surface uniformity of the anode electrode is improved. The baking process is subsequently performed to remove the interlayer, thereby forming the anode electrode.

However, since the interlayer is formed on entire surfaces of the phosphor and black layers, the anode electrode is also spaced apart from the black layer that is a non-active area when the interlayer is removed. That is, since the anode electrode contacts the second substrate only at its periphery, the contacting area of the anode electrode with the second substrate may be too small to provide for a sufficient adhering force to the second substrate.

As a result, when the interlayer is not effectively discharged to an external side through fine pores of the anode electrode during the baking process, the anode electrode may swell to a point in which it is partly delaminated or damaged by contact with spacers of the display. Since the light may not be effectively reflected on the delaminated or damaged portion of the anode electrode, a luminance of a portion of the phosphor layer, which corresponds to the delaminated or damaged portion of the anode electrode, may be deteriorated, thereby adversely affecting color purity.

In addition, the anode electrode is designed to cover all of the phosphor layers on the second substrate. Therefore, when the visible light, which is emitted from a phosphor layer of a specific pixel toward the first substrate, is reflected back to the second substrate by the anode electrode, the visible light may be scattered to a different color phosphor layer of an adjacent pixel, thereby further deteriorating the color purity and color reproduction rate of the screen.

### SUMMARY OF THE INVENTION

Aspects of the present invention provide an electron emission display that can (a) improve (or heighten) a screen luminance, color purity, and color reproduction rate, (b) enhance (or increase) an adhering force of an anode electrode to the second substrate, and/or (c) maximize a light reflection efficiency by optimizing (or increasing) a distance between the anode electrode and the phosphor layer.

In an exemplary embodiment of the present invention, an electron emission display includes first and second substrates facing each other. The second substrate has a plurality of pixel regions defined thereon. A plurality of electron emission elements are disposed on the first substrate. A phosphor screen including phosphor and black layers are formed on a surface of the second substrate. An anode electrode formed of metal is located on surfaces of the phosphor and black layers. The anode electrode includes a spaced portion corresponding to the phosphor layers and spaced apart from the phosphor screen, and includes contact portions contacting the phosphor screen, and satisfies the condition

0.05≦B/A≦0.8,

where A indicates an area of one of said pixel regions defined on the second substrate and B denotes an area occupied by one of the contact portions in the one of said pixel regions.

In another exemplary embodiment, each of the spaced portions may have a size substantially equal to a size of a corresponding one of the phosphor layers.

In another exemplary embodiment, the black layer includes an opening that is 20% of the one of said pixel regions.

In another exemplary embodiment, the anode electrode may further satisfy the following condition:

0.2≦B/A≦0.6.

In another exemplary embodiment, the phosphor layers may include red, green, and blue phosphor layers, each located on a corresponding one of said pixel regions.

In another exemplary embodiment, the electron emission display may further include spacers corresponding to the black layer and located between the first and second substrates.

In another exemplary embodiment, the anode electrode may have openings corresponding to each of the spacers.

In another exemplary embodiment, the electron emission elements are FEA (Field Emitter Array) type electron emission elements, MIM (Metal-Insulator-Metal) type electron emission elements, MIS (Metal-Insulator-Semiconductor) type electron emission elements, or SCE (Surface Conduction Emitter) type electron emission elements.

### BRIEF DESCRIPTION OF THE DRAWINGS

FIG. 1 is a schematic sectional view of an electron emission display according to an exemplary embodiment of the present invention.

FIG. 2 is a partial top view of a light emission unit of the electron emission display of FIG. 1.

FIG. 3 is a partial exploded perspective view of an electron emission display having FEA type electron emission elements according to an exemplary embodiment of the present invention.

FIG. 4 is a partial sectional view of the electron emission display of FIG. 3.

FIG. 5 is a partial sectional view of an electron emission display having SCE type electron emission elements according to an exemplary embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

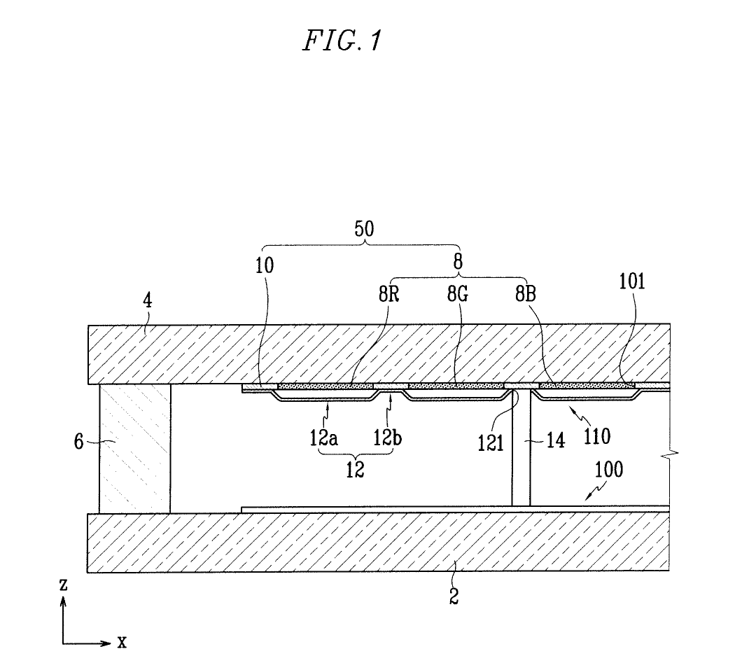

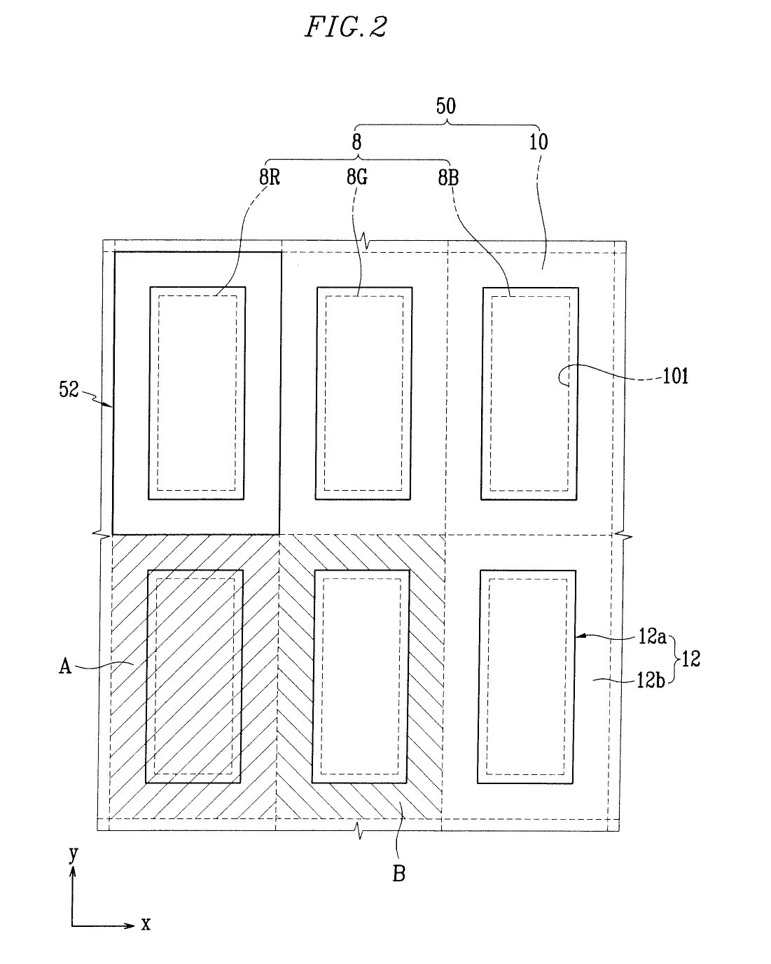

FIG. 1 is a schematic sectional view of an electron emission display according to an exemplary embodiment of the present invention, and FIG. 2 is a partial top view of a light emission unit of the electron emission display of FIG. 1.

Referring to FIG. 1, an electron emission display includes first and second substrates 2 and 4 facing each other in parallel and spaced apart from each other (e.g., by a predetermined distance). A sealing member 6 is provided at the peripheries of the first and second substrates 2 and 4 to seal them together, thereby forming a vessel. The interior of the vessel is exhausted to be kept to a degree of vacuum of about 10⁻⁶ Torr.

An electron emission unit 100 on which electron emission elements are arrayed is provided on a surface of the first substrate 2 opposite the second substrate 4, and a light emission unit 110 including phosphor layers 8, a black layer 10, and an anode electrode 12 is provided on a surface of the second substrate 4 opposite the first substrate 2.

The electron emission elements of the electron emission unit 100 may be one of an FEA-type, an SCE-type, an MIM-type, and an MIS-type of electron emission element. The electron emission unit 100 includes electron emission regions and driving electrodes. The electron emission unit 100 emits the electrons for each pixel. By the emitted electrons, the phosphor layers 8 of the corresponding pixels are excited to emit visible light. An intensity of the emitted visible light corresponds to an amount of the emitted electrons.

In more detail, the phosphor layers 8, e.g., red, green and blue phosphor layers 8R, 8G, 8B, are formed on the second substrate 4 and spaced apart from each other (e.g., by a predetermined distance). The black layer 10 for enhancing a screen contrast is formed between the phosphor layers 8. The phosphor layers 8 are arranged to correspond to the respective pixels.

An anode electrode 12 that is a metal layer formed of, for example, aluminum (Al), is formed on the phosphor layers 8. The anode electrode 12 is externally applied with a high voltage required for accelerating electron beams (formed by the emitted electrons) to maintain the phosphor layers 8 in a high electric potential state. The anode electrode 12 increases the screen luminance by reflecting visible light, which is emitted from the phosphor layers 8 toward the first substrate 2, toward the second substrate 4.

A transparent conductive layer (not shown) functioning as a sub-anode electrode may be formed on surfaces of the phosphor and black layers 8 and 10 opposite the second substrate 4. The transparent conductive layer may be formed of indium tin oxide (ITO).

Located between the first and second substrates 2 and 4 are spacers 14 for uniformly maintaining a gap between the first and second substrates 2 and 4, even when an external force is applied to the first and second substrates 2 and 4. The spacers 14 are arranged to correspond in location to the black layer 10 so as not to interfere with a light emission of the phosphor layers 8. For simplicity, only one spacer is illustrated in FIG. 1.

In the above-described structure, referring to phosphor layers 8 and the black layer 10 as a phosphor screen 50 (illustrated in FIG. 2), the anode electrode 12 includes spaced portions 12a that are spaced apart from the phosphor screen 50 and contact portions 12b that are respectively formed between adjacent pairs of the spaced portions 12a while contacting the phosphor screen 50.

The spaced portions 12a of the anode electrode 12 are individually located to correspond respectively to the phosphor layers 8. The contact portions 12b are located to correspond to the black layer 10. A size of each of the space portions 12a may be equal to or greater than that of the corresponding phosphor layer 8. The contact portions 12b may fully or partly contact the black layer 10.

The above-described anode electrode 12 may be formed by forming an interlayer (not shown) on a portion of the phosphor screen 50, on which the spaced portions 12a will be formed, i.e., on the phosphor layers 8, depositing metal on the interlayer, and vaporizing the interlayer through a baking process. Portions of the anode electrode 12, which are located on the interlayer, become the spaced portions 12a and portions of the anode electrode 12, which are located on portions where no interlayer is located, become the contact portions 12b.

The phosphor layers 8 (8R, 8G and 8B) are located to correspond to respective pixel regions defined on the second substrate 4. That is, one pixel region defined on the second substrate 4 corresponds to one phosphor layer 8 and the black layer 10 surrounding the phosphor layer 8. For convenience, one pixel region is referred to as an individual pixel region 52 (illustrated in FIG. 2). By way of example, as shown in FIG. 2, each of the phosphor layers 8R, 8G, 8B is located at a center of the respective individual pixel region 52.

In the present exemplary embodiment, the anode electrode 12 is formed to satisfy the following Equation 1:

0.05≦B/A≦0.8, Equation 1

where A indicates an area of the individual pixel region 52 and B denotes an area occupied by the contact portion 12b in the individual pixel region 52. For example, the areas A and B are shaded in FIG. 2 for clarity.

In one exemplary embodiment, in order to reliably form the anode electrode 12 on the phosphor screen 50, a contact area of the anode electrode 12 with the black layer 10 must be at least 5% of the area of the individual pixel region 52. That is, when a ratio of the area B of the contact portion 12b to the area A of the individual pixel region 52 is less than 0.05, the anode electrode 12 may be delaminated from the phosphor layer 8, thereby deteriorating the screen luminance.

In one exemplary embodiment, when the area of the contact portion 12b is greater than 20% of the area of the individual pixel region 52, the adhering force of the anode electrode 12 to the phosphor screen 50 may be further enhanced and thus the anode electrode 12 can be more stably formed on the phosphor screen.

In one exemplary embodiment, if a portion of the individual pixel region 52 on which the phosphor layer 8 is formed is represented by an opening 101 of the black layer 10, the opening 101 of the black layer 10 (i.e., the phosphor layer 8) should be at least 20% of the area A of the individual pixel region 52 in order to provide a sufficient light emission.

Therefore, in one exemplary embodiment, a maximum contact area of the anode electrode 12 with the black layer 10 in the individual pixel region 52, i.e., a maximum contact area of the contact portion 12b, is 80% of the individual pixel region 52, which excludes the portion where the phosphor layer 8 is formed.

When the contact portion 12b of the anode electrode 12 making a contact with the black layer 10 extends to a boundary between the black layer 10 and the phosphor layer 8, the light reflection effect may be deteriorated as a result of a portion of the anode electrode 12 making contact with a periphery of the phosphor layer 8. To prevent this, the spaced portion 12a may be formed to have a greater area than the phosphor layer 8.

Therefore, the spaced portion 12a of the anode electrode 12 may be formed to be greater in area than the phosphor layer 8, and the contact portion 12b may be formed to partly contact the black layer 10. Hence, the area of the contact portion 12b may be 0.6 times the area A of the individual pixel region 52.

That is, the anode electrode 12 may be formed to further satisfy the following Equation 2:

0.2≦B/A≦0.6. Equation 2

In one exemplary embodiment, the anode electrode 12 satisfying Equation 2 obtains a maximum contact area with the black layer 10 and thus the contacting force with the black layer 10 is improved. Since the contact portions 12b are arranged around the phosphor layer 8 and spaced apart from each other by a predetermined interval, the light reflection effect of the anode electrode 12 can be improved or maximized.

In addition, since the anode electrode 12 has the spaced portions 12a that individually correspond to the respective phosphor layers 8, the visible light emitted from the phosphor layers 8 of the different individual pixel regions 52 are not scattered toward each other, thereby improving the color purity and the color reproduction rate of the phosphor layers 8.

The anode electrode 12 may be provided with openings corresponding to the respective spacers 14 so that the spacers 14 can directly contact the black layer 10, thereby preventing the anode electrode 12 from being damaged by the spacer 14 during the process of sealing the first and second substrates 2 and 4.

As described above, in the electron emission display device according to one exemplary embodiment of the present invention, the contact area between the black layer 10 and the anode electrode 12 is improved or optimized and thus the delaminating of the anode electrode 12 from the phosphor layers can be prevented or reduced, thereby improving the screen luminance, the color reproduction rate, and the color purity.

The electron emission display may be classified according to a type of the electron emission element thereof. Namely, depending on whether an FEA-type, an SCE-type, an MIM-type, or an MIS-type of electron emission element is employed, the electron emission display may be classified accordingly.

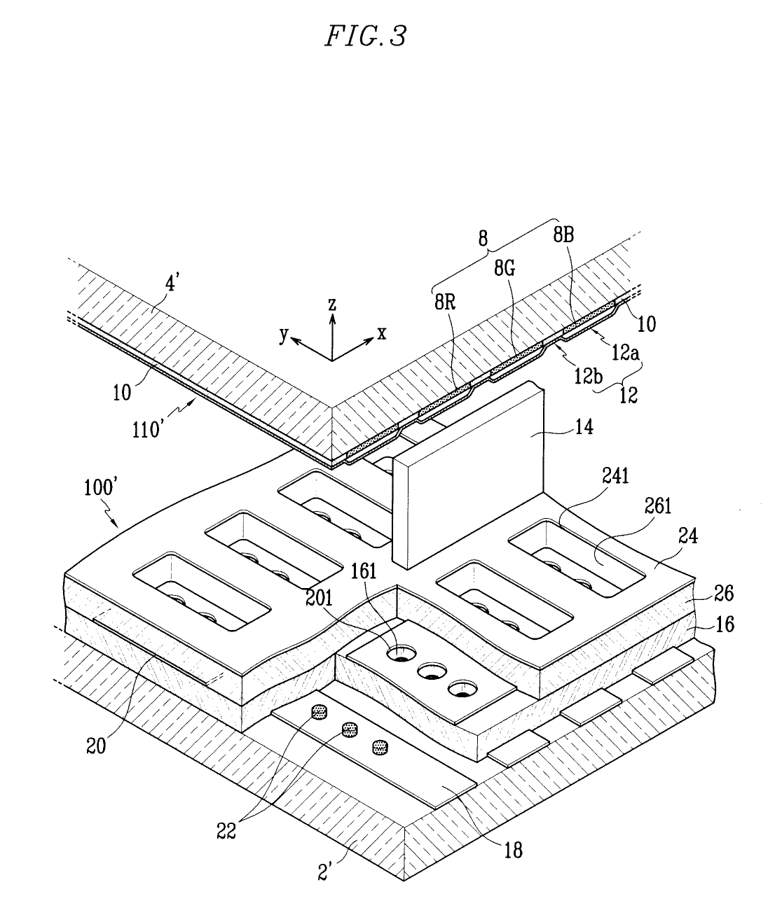

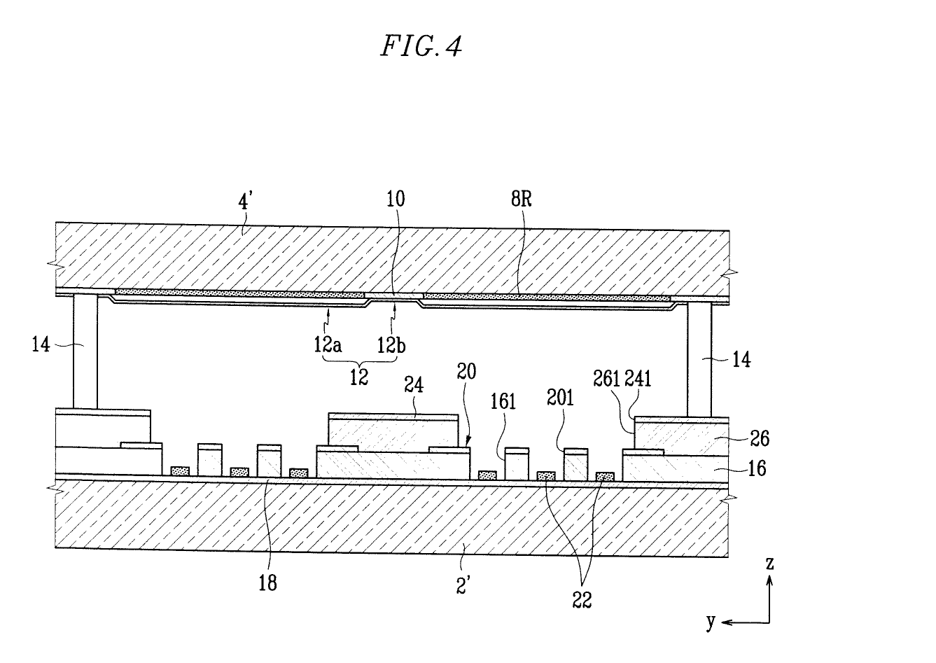

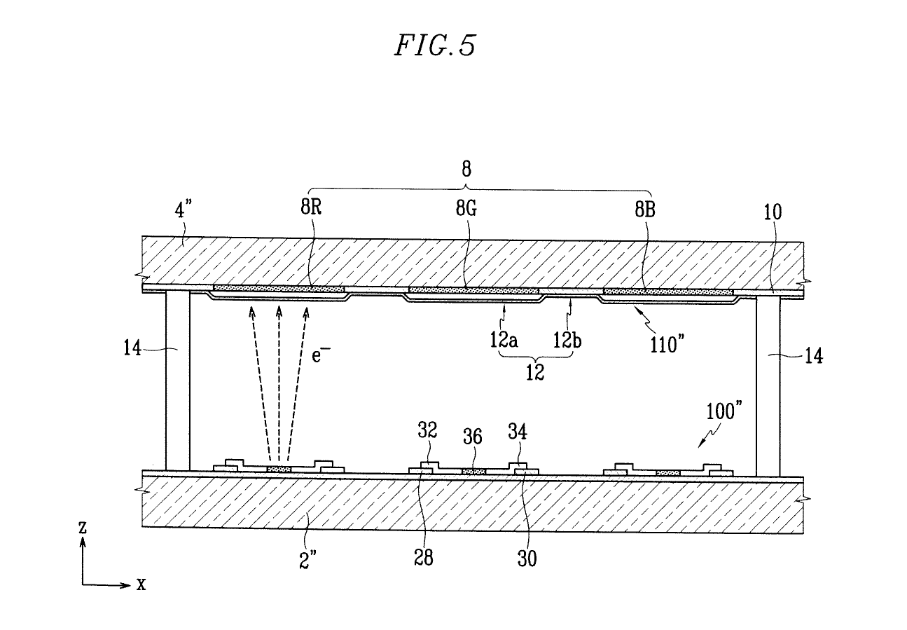

An electron emission display having FEA type electron emission elements and the anode electrode 12 satisfying the above-described conditions will be described with reference to FIGS. 3 and 4. An electron emission display having SCE type electron emission elements, and the anode electrode 12 satisfying the above-described condition will be also described with reference to FIG. 5.

Referring to FIGS. 3 and 4, an electron emission unit 100′ of the FEA-type electron emission display includes a plurality of cathode electrodes 18 and a plurality of gate electrodes 20 crossing the cathode electrodes 18 at right angles with a first insulation layer 16 interposed between the cathode and gate electrodes 18 and 20.

When each crossing region of the cathode and gate electrodes 18 and 20 is defined as a pixel region, one or more electron emission regions 22 are formed on each pixel region. First openings 161 and second openings 201 corresponding to the electron emission regions 22 are respectively formed in the first insulation layer 16 and the gate electrodes 20 to expose the electron emission regions 22 on a first substrate 2′.

The electron emission regions 22 may be formed of a material which emits electrons when an electric field is applied thereto under a vacuum atmosphere, such as a carbonaceous material or a nanometer-sized material. For example, the electron emission regions 22 may be formed of carbon nanotubes, graphite, graphite nanofibers, diamonds, diamond-like carbon, C₆₀, silicon nanowires, or any suitable combination thereof.

Alternatively, the electron emission regions 22 may be formed in a tip structure formed of a Mo-based or Si-based material.

A second insulation layer 26 is formed on the first insulation layer 16 while covering the gate electrodes 20. A focusing electrode 24 is formed on the second insulation layer 26. Hence, the focusing electrode 24 is insulated from the gate electrodes 20 by the second insulation layer 26. Openings 241 and openings 261 through which electron beams pass are respectively formed in the focusing electrode 24 and the second insulation layer 26.

The openings 241 of the focusing electrode 24 may correspond to the respective electrode emission regions 22 to individually converge the electrons emitted from each electron emission region 22. Alternatively, the openings 241 of the focusing electrode 24 may correspond to the respective pixel regions to generally converge the electrons emitted from the electron emission regions 22 of each pixel region.

A light emission unit 110′ provided on the second substrate 4′ includes phosphor layers 8, a black layer 10, and an anode electrode 12 satisfying the Equation 1. Since the structure of the light emission unit 110′ is substantially identical to that of FIG. 1, a detailed description thereof will be omitted herein.

The FEA-type electron emission display is driven when suitable voltages (e.g., predetermined voltages) are respectively applied to the cathode, gate, focusing, and anode electrodes 18, 20, 24, and 12.

For example, one of the cathode and gate electrodes 18 and 20 functions as a scan electrode for receiving a scan driving voltage and the other functions as a data electrode for receiving a data driving voltage. The focusing electrode 24 receives a negative direct current voltage of 0 or several to tens of volts required for converging the electron beams. The anode electrode 12 receives a direct current voltage of, for example, hundreds to thousands of volts that can accelerate the electron beams.

Electric fields are formed around the electron emission regions 22 at the unit pixels where a voltage difference between the cathode and gate electrodes 18 and 20 is equal to or higher than a threshold value and thus the electrons are emitted from the electron emission regions 22. The emitted electrons converge to a central portion of a bundle of the electron beams while passing through the openings 241 of the focusing electrode 24, and strike the phosphor layers 8 of the corresponding unit pixel by the high voltage applied to the anode electrode 12, thereby exciting the phosphor layers 8 to realize an image.

Referring to FIG. 5, an electron emission unit 100″ of an SCE-type electron emission display includes a first substrate 2″, first and second electrodes 28 and 30 formed on the first substrate 2″ and spaced apart from each other, first and second conductive layers 32 and 34 that are respectively formed on the first and second electrodes 28 and 30 and located in close proximity to each other, and electron emission regions 36 formed between the first and second conductive layers 32 and 34.

The first and second electrodes 28 and 30 may be formed of a variety of conductive materials. The first and second conductive layers 32 and 34 may be particle thin layers formed of nickel (Ni), gold (Au), platinum (Pt), or palladium (Pd). The electron emission regions 36 provided between the first and second conductive layers 32 and 34 may be fine-cracked or formed of graphite or carbon compound.

A light emission unit 110″ is provided on a second substrate 4″. The light emission unit 110″ may include phosphor layers 8, a black layer 10, and an anode electrode 12 satisfying the above-described conditions. Since the structure of the light emission unit 110″ is substantially identical to that of FIG. 1, a detailed description thereof will be omitted herein.

When voltages are applied to the first and second electrodes 28 and 30, an electric current flows in a direction that is substantially parallel to surfaces of the electron emission regions 36 through the first and second conductive layers 32 and 34 and thus the electron emission regions 36 emit electrons. The emitted electrons travel toward the second substrate 4″ by the high voltage applied to the anode electrode 12 and strike the phosphor layers 8 of the corresponding unit pixel, thereby exciting the phosphor layers 8 to realize an image.

According to the electron emission display in exemplary embodiments of the present invention, since the contact area between the anode electrode and the black layer is improved or optimized, the adhering force of the anode electrode to the black layer can be enhanced and the light reflection effect of the anode electrode can be improved or maximized.

Therefore, the electron emission display in exemplary embodiments of the present invention prevents the anode electrode from being delaminated and thus the light reflection effect, color purity, and color reproduction rate thereof can be improved.

While the present invention has been described in connection with certain exemplary embodiments, it will be appreciated by those skilled in the art that the invention is not limited to the disclosed embodiments, but, on the contrary, is intended to cover various modifications included within the principles and spirit of the invention, the scope of which is defined in the claims and their equivalents.

What is claimed is:

1. An electron emission display comprising:
a first substrate and a second substrate facing each other, the second substrate having a plurality of pixel regions defined thereon;
a plurality of electron emission elements disposed on the first substrate;
a phosphor screen including phosphor layers and a black layer, wherein the phosphor screen is disposed on the second substrate; and
an anode electrode formed of metal and located on the phosphor layers and the black layer,
wherein the anode electrode comprises spaced portions corresponding to the phosphor layers and spaced apart from the phosphor screen, and contact portions contacting the phosphor screen, wherein the anode electrode satisfies the condition
0.05≦B/A≦0.8,
wherein A indicates an area of one of said pixel regions defined on the second substrate and B denotes an area occupied by one of the contact portions in the one of said pixel regions.

2. The electron emission display of claim 1, wherein each of the spaced portions has a size substantially equal to a size of a corresponding one of the phosphor layers.

3. The electron emission display of claim 2, wherein the black layer has an opening that is at least 20% of the area of the one of said pixel regions.

4. The electron emission display of claim 2, wherein the anode electrode further satisfies the following condition:
0.2≦B/A≦0.6.

5. The electron emission display of claim 2, wherein the phosphor layers include red phosphor layers, green phosphor layers, and blue phosphor layers, each located in a corresponding one of said pixel regions.

6. The electron emission display of claim 1, further comprising spacers corresponding to the black layer and located between the first substrate and the second substrate.

7. The electron emission display of claim 6, wherein the anode electrode has openings corresponding to the spacers.

8. The electron emission display of claim 6, wherein the electron emission elements are Field Emitter Array type electron emission elements, Metal-Insulator-Metal type electron emission elements, Metal-Insulator-Semiconductor type electron emission elements, or Surface Conduction Emitter type electron emission elements.

9. An electron emission display comprising:
a first substrate and a second substrate facing each other, the second substrate having a plurality of pixel regions defined thereon;
a plurality of electron emission elements disposed on the first substrate;
a phosphor screen including phosphor layers and a black layer, wherein the phosphor screen is disposed on the second substrate; and
an anode electrode formed of metal and located on the phosphor layers and the black layer,
wherein the anode electrode comprises spaced portions corresponding to the phosphor layers and spaced apart from the phosphor screen, and contact portions contacting the black layer of the phosphor screen, wherein the contact portions make contact with portions of the black layer between the phosphor layers.

10. The electron emission display as claimed in claim 9, wherein the anode electrode satisfies the condition 0.05≦B/A≦0.8, A indicating an area of one of said pixel regions defined on the second substrate and B denoting an area occupied by one of the contact portions in the one of said pixel regions.

11. The electron emission display of claim 10, wherein each of the spaced portions has a size substantially equal to a size of a corresponding one of the phosphor layers.

12. The electron emission display of claim 11, wherein the black layer has an opening that is at least 20% of the area of the one of said pixel regions.

13. The electron emission display of claim 11, wherein the anode electrode further satisfies the following condition:
0.2≦B/A≦0.6.

14. The electron emission display of claim 11, wherein the phosphor layers include red phosphor layers, green phosphor layers, and blue phosphor layers, each located in a corresponding one of said pixel regions.

15. The electron emission display of claim 10, further comprising spacers located on the black layer between the first substrate and the second substrate.

16. The electron emission display of claim 15, wherein the anode electrode has openings corresponding to the spacers.

17. The electron emission display of claim 15, wherein the electron emission elements are Field Emitter Array type electron emission elements, Metal-Insulator-Metal type electron emission elements, Metal-Insulator-Semiconductor type electron emission elements, or Surface Conduction Emitter type electron emission elements.

18. A method of preventing an anode electrode from delaminating in an electron emission display having a first substrate and a second substrate facing each other, a phosphor screen including phosphor layers and a black layer formed on the second substrate to provide a plurality of pixel regions, and an anode electrode formed of metal and located on the phosphor layers and the black layer, the method comprising:
forming the anode electrode to have spaced portions corresponding to the phosphor layers and contact portions making contact with the black layer, the contact portions being located between the phosphor layers.

19. The method as claimed in claim 18, wherein the anode electrode satisfies the condition 0.05≦B/A≦0.8, A indicating an area of one of said pixel regions defined on the second substrate and B denoting an area occupied by one of the contact portions in the one of said pixel regions.

20. The method as claimed in claim 19, wherein the anode electrode further satisfies the condition 0.2≦B/A≦0.6, with each of the spaced portions having a size substantially equal to a size of a corresponding one of the phosphor layers.
